(19) United States
(12) Patent Application Publication
(10) Pub. No.: US 2017/0089828 A1
(43) Pub. Date: Mar. 30, 2017

(54) CORROSION SENSOR

(71) Applicant: Carrier Corporation, Palm Beach Gardens, FL (US)

(72) Inventors: Kerry Allahar, Syracuse, NY (US); Matthew Patterson, Syracuse, NY (US)

(21) Appl. No.: 15/279,123

(22) Filed: Sep. 28, 2016

Related U.S. Application Data
(60) Provisional application No. 62/233,862, filed on Sep. 28, 2015.

(51) Int. Cl. G01N 17/02; G01N 27/403

(52) U.S. Cl. CPC G01N 17/02; G01N 27/403

(57) ABSTRACT

A corrosion sensor including a cathodic metallic layer configured to allow moisture to pass therethrough, and an anodic metallic layer affixed to the cathodic metallic layer such that an air gap is formed therebetween.

### CROSS-REFERENCE TO RELATED APPLICATIONS

The present application is a nonprovisional patent application, which claims priority to 62/233,862, filed Sep. 28, 2016, which is herein incorporated in its entirety.

### TECHNICAL FIELD OF THE DISCLOSED EMBODIMENTS

The presently disclosed embodiments generally relate to devices configured to monitor corrosion impacts, and more particularly, to a corrosion sensor.

### BACKGROUND OF THE DISCLOSED EMBODIMENTS

Generally, corrosion is the degradation of metal caused by a reaction with the environment, such as oxidation and chemical attack of the metallic surface. Copper, for example, is susceptible to attack from sulfur-containing gases. The result is the formation of a nonproductive layer on the material surface. Generally, unprotected metal will continue to react with the contaminant and corrode. Left unchecked and under prolonged conditions, the metal continues to corrode until the integrity of the metal is jeopardized.

Accordingly, there exists a need for a corrosion sensor that can monitor the degradation of metal in real time to create an early warning system.

### SUMMARY OF THE DISCLOSED EMBODIMENTS

In one aspect, a corrosion sensor is provided. The corrosion sensor includes a cathodic metallic layer configured to allow moisture to pass therethrough, and an anodic metallic layer affixed to the cathodic metallic layer such that an air gap is formed therebetween. In one embodiment, the cathodic metallic layer is composed of a corrosion-resistant metallic mesh, where in some embodiments; the corrosion-resistant metallic mesh is composed of a noble metal.

In an embodiment, the anodic metallic layer includes a first metal and the cathodic metallic layer includes a second metal, and wherein the first metal is less noble than the second metal. In an embodiment, the anodic metallic layer comprises aluminum.

In each of the preceding embodiments, the cathodic metallic layer and anodic metallic layer are disposed within a housing. In an embodiment, the housing is sealed along a perimeter. In some embodiments, the corrosion sensor further includes an electrically conductive layer disposed within the air gap. In an embodiment, the electrically conductive layer is composed of a fabric configured to retain moisture. In another embodiment, the anodic metallic layer includes a metal surface of an HVAC&R appliance

In each embodiment, the corrosion sensor further includes a data logger operably coupled to the cathodic metallic layer and the anodic metallic layer. In an embodiment, the data logger is configured to measure an electrical parameter.

In an embodiment, the data logger is configured to determine a corrosion level based at least in part on a measured galvanic current flowing from the cathodic metallic layer through the anodic metallic layer. In another embodiment, the data logger is configured to determine a corrosion level based at least in part on a measured galvanic potential between the cathodic metallic layer and the anodic metallic layer.

### BRIEF DESCRIPTION OF DRAWINGS

FIG. 1 illustrates a cross-sectional view of a schematic diagram of a corrosion sensor according to an embodiment of the present disclosure; and

FIG. 2 illustrates a cross-sectional view of a schematic flow diagram of a corrosion sensor according to another embodiment of the present disclosure.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

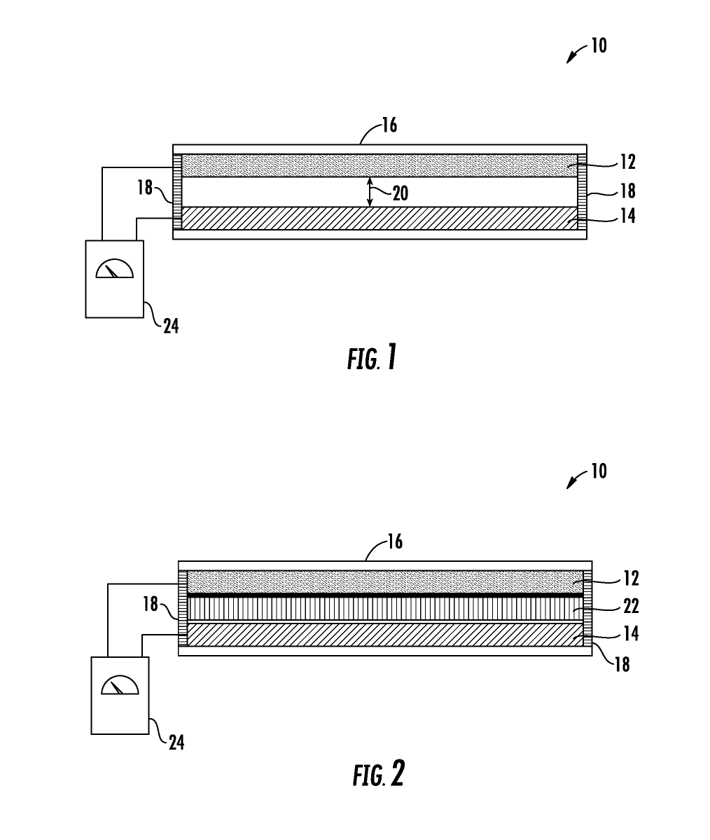

FIG. 1 schematically illustrates an embodiment of a corrosion sensor, generally indicated at 10. The corrosion sensor 10 includes a cathodic metallic layer 12 and an anodic metallic layer 14. The cathodic metallic layer 12 and an anodic metallic layer 14 can be disposed within a housing 16. The housing 16 is configured to have an opening located adjacent to the cathodic metallic layer 12 to allow moisture to pass therethrough. In some embodiments, the perimeter of the housing 16 is sealed. It will be appreciated that the perimeter of the housing may be sealed by any material suitable to create a water-tight seal around the perimeter. The corrosion sensor 12 is configured to be placed on or near any metal surface exposed to the environment. The metal surface may be part of an appliance, such as an HVAC appliance to name one non-limiting example, to monitor and estimate the corrosive impact of the environment on the appliance.

In an embodiment, the cathodic metallic layer 12 is positioned and affixed to the anodic metallic layer 14 via an adherent 18 (e.g. epoxy) such that an air gap 20 is created therebetween. The cathodic metallic layer 12 is configured to allow moisture to pass therethrough. For example, in operation, the cathodic metallic layer 12 is exposed to the environment such that moisture may enter the corrosion sensor 10 and pass through the cathodic metallic layer 12 and come into contact with the anodic metallic layer 14.

In an embodiment, the cathodic metallic layer 12 includes a corrosion-resistant metallic mesh including a noble metal (e.g., which are resistant to corrosion and oxidation in moist air). For example, the corrosion-resistant metallic mesh may include platinum, gold, copper, rhodium, palladium, and silver to name a few non-limiting examples. The corrosion-resistance metallic mesh may be any size and shape, and also have any number of holes/openings therein. In some embodiments, the area of the corrosion-resistance metallic mesh may be greater than or equal to approximately 1 square inch. It will be appreciated that the area of the corrosion-resistance metallic mesh may be less than or approximately 1 square inch. For example, the corrosion-resistance metallic mesh may be a 1 inch by 1 inch platinum mesh wire with a diameter of approximately 0.024 in. and has 160 holes/openings per square inch to name one non-limiting example.

In an embodiment, the anodic metallic layer 14 includes a metal less noble than the cathodic metallic layer 12. In an embodiment, the anodic metallic layer 14 includes aluminum. For example, an outdoor HVAC unit can generally include aluminum fins mechanically bonded to copper tubes. As such, a user may select aluminum as a metal of interest to determine the real time corrosion of the aluminum fins in the outdoor HVAC unit. It will be appreciate the anodic metallic metal 14 may also include a ferrous material, steel, and an aluminum alloy, or a combination including at least one of the foregoing to name a few non-limiting examples. In an embodiment, as shown in FIG. 2, the corrosion sensor 10 includes an electrically conductive layer 22, for example a material that is capable of conducting electrical current through the layer alone or in combination with another material. The electrically conductive layer 22 can be disposed between the cathodic metallic layer 12 and the anodic metallic layer 14. It will be appreciated that the electrically conductive layer 22 may initially be electrically non-conductive, and may become electrically conductive periodically in response to environmental conditions such as by interaction with airborne moisture (e.g. rain, humidity, and sea spray to name a few non-limiting examples).

The electrically conductive layer 22 can be disposed within the air gap, and can be configured to at least periodically retain moisture from the environment that passes through the cathodic metallic layer 12. For example, the electrically conductive layer 22 may become wet due to a wetting event in the environment (e.g., rain, snow, etc.); however, due to the conditions within the environment, the electrically conductive layer 22 may dry until the next wetting event. In an embodiment, the electrical conductive layer 22 includes a fabric configured to at least periodically retain moisture. For example, the electrical conductive layer 22 includes a cotton fabric to name one non-limiting example.

In an embodiment, the corrosion sensor 10 further includes a data logger 24 operably coupled to the cathodic metallic layer 12 and the anodic metallic layer 14. In an embodiment, the data logger 24 may include a logger configured to measure an electrical parameter. It will be appreciated that the data logger may measure any electrical parameter, such as current, voltage, resistance, inductance, impedance, capacitance, etc., to name a few non-limiting examples.

For example, a current data logger 24 is configured to determine a corrosion level based at least in part on a measured galvanic current flowing from the cathodic metallic layer 12 through the anodic metallic layer 14. A voltage data logger 24 is configured to determine a corrosion level based at least in part on a measured galvanic potential between the cathodic metallic layer 12 and the anodic metallic layer 14. In some embodiments, the data logger 24 may include a communication module (not shown) disposed therein to transmit the measured galvanic current to relevant users, and/or transmit an alert signal to relevant users when the measured galvanic current/potential exceeds a predetermined limit.

For example, moisture from the environment (e.g. seawater) may contain electrolytes. These electrolytes can include sodium or calcium chloride compounds. Other electrolyte sources include sulfur and nitrogen compounds generated by combustion of coal and fuel oils. An electrolyte in the presence of the copper-tube and aluminum-fin, within an outdoor HVAC unit, is sufficient to initiate a corrosion reaction. The current data logger 24 measures the flow of galvanic current between the cathodic metallic layer 12 and the anodic metallic layer 14. As such, based on the measured galvanic current, a user is able to determine the level of corrosion within the metal of interest, and take the appropriate actions, if necessary.

In another embodiment, the anodic metallic layer 14 comprises a metal surface of an HVAC&R appliance. For example, the corrosion sensor 10 may be located such that the metal surface of an HVAC&R appliance is the metal of interest. As such the cathodic metallic layer 12 and the electrically conductive layer 22are placed onto the metal surface of an HVAC&R appliance.

It will therefore be appreciated that the present embodiments includes a corrosion sensor 10 containing a cathodic metallic layer 12 configured to allow moisture to pass therethrough, and an anodic metallic layer 14 affixed to the cathodic metallic layer 12 to provide real time data of the corrosion impact for a metal of interest.

While the present disclosure has been illustrated and described in detail in the drawings and foregoing description, the same is to be considered as illustrative and not restrictive in character, it being understood that only certain embodiments have been shown and described and that all changes and modifications that come within the spirit of the present disclosure are desired to be protected. The terms “a” and “an” and “the” herein do not denote a limitation of quantity, and are to be construed to cover both the singular and the plural, unless otherwise indicated herein or clearly contradicted by context.

What is claimed is:

1. A corrosion sensor comprising:
a cathodic metallic layer configured to allow moisture to pass therethrough; and
an anodic metallic layer affixed to the cathodic metallic layer such that an air gap is formed therebetween.

2. The corrosion sensor of claim 1, wherein the cathodic metallic layer and anodic metallic layer are disposed within a housing.

3. The corrosion sensor of claim 2, wherein the housing is sealed along a perimeter.

4. The corrosion sensor of claim 1, further comprising an electrically conductive layer disposed within the air gap.

5. The corrosion sensor of claim 4, wherein the electrically conductive layer comprises a fabric configured to at least periodically retain moisture.

6. The corrosion sensor of claim 5, wherein the moisture is derived from the environment.

7. The corrosion sensor of claim 1, wherein the cathodic metallic layer comprises a corrosion-resistant metallic mesh.

8. The corrosion sensor of claim 5, wherein the corrosion-resistant metallic mesh comprises a noble metal.

9. The corrosion sensor of claim 1, wherein the anodic metallic layer comprises a first metal and the cathodic metallic layer comprises a second metal, and wherein the first metal is less noble than the second metal.

10. The corrosion sensor of claim 9, wherein the anodic metallic layer comprises aluminum.

11. The corrosion sensor of claim 1, further comprising a data logger operably coupled to the cathodic metallic layer and the anodic metallic layer.

12. The corrosion sensor of claim 11, wherein the data logger is configured to measure an electrical parameter.

13. The corrosion sensor of claim 12, wherein the data logger is configured to determine a corrosion level based at least in part on a measured galvanic current flowing from the cathodic metallic layer to the anodic metallic layer.

14. The corrosion sensor of claim 12, wherein the data logger is configured to determine a corrosion level based at least in part on a measured galvanic potential between the cathodic metallic layer and the anodic metallic layer.

15. The corrosion sensor of claim 1, wherein the anodic metallic layer comprises a metal surface of an HVAC&R appliance.
